(19) United States
(12) Patent Application Publication
(10) Pub. No.: US 2014/0234483 A1
(43) Pub. Date: Aug. 21, 2014

(54) STRUCTURAL FAT FOR THE PRODUCTION OF LOW SATURATED, ZERO TRANS FATTY ACIDS MARGARINE, FAT SPREADS, ICINGS, FROSTINGS, SHORTENINGS AND FOOD PRODUCTS

(71) Applicants: Jose Anibal Trujillo-Quijano, Dubai (AE); Merry Kurian, Dubai (AE)

(72) Inventors: Jose Anibal Trujillo-Quijano, Dubai (AE); Merry Kurian, Dubai (AE)

(73) Assignee: International Foodstuffs Company LLC, Sharjah (AE)

(21) Appl. No.: 14/260,075

(22) Filed: Apr. 23, 2014

Related U.S. Application Data
(63) Continuation-in-part of application No. 13/465,430, filed on May 7, 2012, now abandoned.

(51) Int. Cl. A23D 9/04

(52) U.S. Cl. CPC A23D 9/04
USPC 426/33; 426/607

(57) ABSTRACT

Processes for preparing an edible hard stock are disclosed for use in the formulation of margarines, spreads, icings, shortenings, frostings and other products that need a structural fat to hold at least some liquid unsaturated triglycerides or diglycerides are disclosed, wherein the hard stock is a random interesterified product and has three groups of fats, the process comprises: providing a first group of fats saturated by fractionation or by fully hydrogenation comprising more than 85% of C16:0 and C18:0 type of fatty acids; providing a second group of fats saturated by fractionation or by full hydrogenation comprising more than 75% of C12:0 and C14:0 fatty acids; providing a third group are of triglyceride liquid oils at ambient temperature, that contains C18 with total more than 80%; and producing the edible hard stock by random interestification of the first group, the second group and the third group of fats.

This United States Continuation-in-part application is a continuation of U.S. Utility patent application Ser. No. 13/465,430, which is entitled “Structural Fat for the Production of Low Saturated, Zero Trans Fatty Acids Margarine, Fat Spreads, Icings, Frostings, Shortenings and Food Products and was filed on May 7, 2012, which is commonly-owned and incorporated in its entirety herein by reference.

### BACKGROUND

In the recent years the food industry is working eliminate artificial “trans” Fatty Acids (TFA) in their products originated from partial hydrogenated fats used in the formulation. Further, the food industry is also moving in the direction of reducing saturated fats in their formulations and mainly to have a balanced fatty acid composition.

It was also observed that by replacing trans fats in formulation, the saturated fat level increases, if the same consistency of the fat is required, which is mainly due to contribution of TFA in the consistency and structure of the fat, compared with their natural “cis” isomer which has lower melting points.

U.S. Pat. No. 3,617,308 describes a hard stock made by interesterification of a hydrogenated fat (melting point>50 C) with less C16:0 fatty acids with fully hydrogenated palm kernel oil with in ratios of 25-75: 75-25. This hard stock is blended with a liquid vegetable oil in a ratio of 8-12%.

U.S. Pat. No. 4,341,812 describes the preparation of a hard stock with fully hydrogenated babacu oil (a lauric fat of Brazilian origin) with fully hydrogenated palm oil and interesterified. This hard stock is blended with liquid oil in the range of 5-20% for the production of spreads high in polyunsaturates.

U.S. Pat. No. 4,341,813 describes similar hardstock as the previously mentioned U.S. Pat. No. 4,341,812 but using in pastry and stick margarines. The hard stock is used in levels of 20-30%.

U.S. Pat. No. 4,486,457 relates the use of fully hydrogenated group of C16-18 fatty acids and other group of C12-14 fatty acid. The hardstocks are used in levels of 4-30% to produce zero trans margarines.

U.S. Pat. No. 6,808,737 B2 (2004) uses fractionated palm stearin and fractionated palm kernel oil. These two components are interesterified. This hard stock is used as structural fats for margarines/spreads in the range of 5-40%. This patent has the same principle of the patents listed above using a lauric and non lauric saturated fats, with the difference that rather than hydrogenation to harden the fat, fractionation is used to separate fractions of high melting points.

U.S. Pat. No. 5,288,619 describes the route of production of margarine fat by enzymatic selective interesterification (1,3 functionally specific lipase) of stearic acid and liquid oil (Eg; Soy bean oil) using solvents (Hexane) in dilution of the fat. After solvent evaporation, the excess of fatty acids are distilled at high vacuum or removed by crystallization and filteration. The interesterification described in current embodiments that are disclosed herein does not require the use of solvents and it uses random chemical or enzymatic interesterification.

U.S. Pat. No. 3,991,088 describes the production of hard stocks for margarine, based on interesterification of partially hydrogenated low erucic rapeseed oil with coconut oil. The hard stock is blended with different oils in different ratios (for example: vegetable oil, hydrogenated fat, palm oil and butter oil.) The disadvantage of the embodiments in this patent is the described and claimed product is not trans free.

According to Food and Drug Administration (FDA)—November 2013, trans fatty acids are no longer considered Generally Considered As Safe (GRAS) and the USA food industries need to reformulate their products avoiding the use of partially hydrogenated fats.

It would therefore be ideal to develop an interesterified hard component that allows the use of high amount of low saturated liquid oils (up to 90%) in the formulation of margarines, spreads or shortenings. In a spread with 40% fat, 85% liquid regular canola or soybean oil with 15% of the hard stock, the saturated fatty acids in the final product will be near 12% and 14.4% respectively. This ideal hard stock allows with a correct combination of liquid oils to adjust a good balance of omega 6 and omega 3 fatty acids in the final product.

### SUMMARY OF THE SUBJECT MATTER

Contemplated processes for preparing an edible hard stock for use in the formulation of margarines, spreads, icings, shortenings, frostings and other products that need a structural fat to hold at least some liquid unsaturated triglycerides or diglycerides are disclosed, wherein the hard stock is a random interesterified product and has three groups of fats, the process comprises: providing a first group of fats saturated by fractionation or by fully hydrogenation comprising more than 85% of C16:0 and C18:0 type of fatty acids; providing a second group of fats saturated by fractionation or by full hydrogenation comprising more than 75% of C12:0 and C14:0 fatty acids; providing a third group are of triglyceride liquid oils at ambient temperature, that contains C18 with total more than 80%; and producing the edible hard stock by random interestification of the first group, the second group and the third group of fats.

### DETAILED DESCRIPTION

An interesterified hard component has been developed that is distinguishable from the references discussed earlier and allows the use of high amount of low saturated liquid oils (up to 90%) in the formulation of margarines, spreads or shortenings. In a contemplated spread with 40% fat, 85% liquid regular canola or soybean oil with 15% of the hard stock, the saturated fatty acids in the final product will be near 12% and 14.4% respectively. This contemplated hard stock allows—with a correct combination of liquid oils—to provide a good balance of omega-6 and omega-3 fatty acids in the final product.

Contemplated embodiments are easily distinguished over earlier referenced patents in that there are three groups of fats that are used rather than two groups of fats. The first group of fats is saturated by fractionation or fully hydrogenation comprising more than 85% C16:0 and C18:0 type of fatty acids. The second group of fats is saturated by fractionation or fully hydrogenation, and contains more than 75% C12:0 and C14:0 type of fatty acids. And the third group of fats comprises triglyceride liquid oils at ambient temperature, which contains more than 80% C18, such as oleic, linoleic or linolenic.

Specifically, contemplated processes for preparing an edible hard stock for use in the formulation of margarines, spreads, icings, shortenings, frostings and other products that need a structural fat to hold at least some liquid unsaturated triglycerides or diglycerides are disclosed, wherein the hard stock is a random interesterified product and has three groups of fats, the process comprises: providing a first group of fats saturated by fractionation or by fully hydrogenation comprising more than 85% of C16:0 and C18:0 type of fatty acids; providing a second group of fats saturated by fractionation or by full hydrogenation comprising more than 75% of C12:0 and C14:0; providing a third group are of triglyceride liquid oils at ambient temperature, that contains C18 with total more than 80%; and producing the edible hard stock by random interestification of the first group, the second group and the third group of fats.

Contemplated hard stocks differ from other listed patents because of the use of three group of fats rather than two groups of fats, thus giving cost advantages and be more flexibility to adjust the melting profile of the hard stock.

Contemplated embodiments also utilize a methodology to produce low saturated fat blends by means of having a hard stock that is able to capture in its crystal net structure the liquid unsaturated oil, after co-crystallization.

The hard stock after blending with the soft liquid oil does not have waxiness or fatty mouth feel. The hard stock is used in the blend of margarine, shortenings, icings or spreads in levels of 2-40%, depending on final consistency of the product. Typically in table margarines, 10-20% of the hard stock is required. The first group of fats saturated by fractionation or fully hydrogenation comprising of more than 85% by C16:0 and C18:0 type of fatty acids, the second group of fats saturated by fractionation or fully hydrogenation containing more than 75% C12:0 and C14:0. The third group comprise triglyceride liquid oils at ambient temperature, that contains more than C18 fatty acids, such as oleic, linoleic or linolenic.

One advantage of having three group of fats having a different fatty acid composition is that one is palmitic and stearic, the other is mainly lauric and miristic and third is unsaturated, which are to be more cost effective than using only two group of fats of one palmitic and stearic base and another that is lauric and miristic base. In using three groups of fats, the requirement of lauric fats is reduced and consequently the cost of the interesterified hard stock is reduced significantly. Interesterification can be conducted either chemical or using inmobilized enzymes.

Contemplated processes comprise a first group of fats, where the group is present in a range of about 25-80%. In some embodiments, the first group of fats is present in a range of about 70-75%. Contemplated processes comprise providing a second group of fats that is present in a range of about 10-35%. In some embodiments, the second group of fats is present in a range of about 22-25%. Contemplated processes comprise providing a third group of fats, where the group of fats is present in a range of about 1-30%. In some embodiments, the third group of fats is present in a range of about 3-5%. These ranges will be illustrated in the Examples Section.

### EXAMPLES

### Example 1

Palm stearin with Iodine value (IV) of 12, palm kernel stearin of IV 5 and refined soybean oil were blended in different proportions and interesterified, the results are presented in Table 1.

Chemical random interesterifications of the blends were carried out in a pilot plant reactor of 50 kg capacity. The oil blend having average 0.08% free fatty acids (as palmitic) was first neutralized to 0.02% max using NaOH solution 7N. The oil was dried at 150° C. at 20 mbar absolute for one hour or until moisture is below 100 ppm. The blend was cooled to 110° C. and the catalyst (sodium methoxide) 0.06% was added. Reaction was carried out at 110° C. for 45 minutes at 20 mbar absolute pressure, under continuous agitation and oil recirculation pumping the blend from bottom to top of the reactor. After reaction citric acid solution of 50% concentration (1.6-2 times of citric acid dry basis on relation to sodium methoxide) was used to stop the reaction and split the soaps, the reaction with citric acid was done for 30 minutes at 95° C. After citric acid treatment, the interesterified blend was bleached using 0.5% acid activated bleaching earth, operation done at 100° C. for 20 minutes at 75 mbar absolute pressure. After filtration the interesterified blend was deodorized at 240° C. for one hour at 2 mbar absolute, direct steam was generated inside the deodorizer pumping distilled/degased water 2% per hour in a pilot batch deodorizer of 50 kg.

TABLE 1
Solid fat content (pNMR) of blends of Palm Stearin IV 12, Palm kernel
Stearin IV 5 (PKS) and Soybean Oil blends before and after chemical
interesterification.

| | BLEND | BLEND | BLEND | BLEND | BLEND | BLEND |
|---|---|---|---|---|---|---|
| TEMPERATURE | No 1 (BI) | No 1 (AF) | No 2 (BI) | No 2 (AF) | No 3 (BI) | No 3 (AF) |
| ° C. | SFC | SFC | SFC | SFC | SFC | SFC |
| 10 | 95.83 | 96.03 | 92.18 | 94.85 | 93.8 | 96.34 |
| 20 | 88.68 | 87.34 | 84.87 | 87.32 | 88.41 | 91.38 |
| 30 | 69.04 | 65.52 | 70.99 | 69.8 | 71.97 | 72.76 |
| 35 | 54.82 | 49.09 | 63.02 | 53.26 | 63.08 | 57.26 |
| 40 | 46.74 | 30.5 | 55.73 | 35.66 | 54.35 | 37.19 |

(BI) = before interesterification.
(AF) = after interesterification.
IV = Iodine value
SFC = Solid Fat Content

Blend 1: palm stearin IV 12/palm stearin IV 5/soybean oil IV 130 (70%/25%/5%)
Blend 2: palm stearin IV 12/palm stearin IV 5/soybean oil IV 130 (75%/20%/5%)
Blend 3: palm stearin IV 12/palm stearin IV 5/soybean oil IV 130 (75%/22%/3%)
SFC AOCS Method—Cd 16b-39.

### Analytical Methods:

All results presented are based on the AOCS (American Oil Chemist's Society); Methods for Solid Fat Content (SFC) Cd 16b-39; Slip Melting Point (SMP) Cc 3-25; Fatty Acid Composition Ce 1-62; Iodine Value (IV) Cd 1d-92

Table 2 shows the results of using palm kernel stearin of IV 7 instead of palm kernel stearin IV 5 are presented.

TABLE 2
Solid Fat Content (pNMR) of Palm Stearin IV 12, Palm Kernel
Stearin IV 7 and Soybean Oil before and after chemical
interesterification.

| | | | BLEND | BLEND |
|---|---|---|---|---|
| | BLEND No 4 | BLEND No 4 | No 5 | No 5 |
| TEMPERATURE | (BI) | (AF) | (BI) | (AF) |
| ° C. | SFC | SFC | SFC | SFC |
| 10 | 93.65 | 96.28 | 91.8 | 94.35 |
| 20 | 88.66 | 90.66 | 84.41 | 88.38 |
| 30 | 74.86 | 72.35 | 67.97 | 68.56 |
| 35 | 67.62 | 57.73 | 59.36 | 52.65 |
| 40 | 60.78 | 41.15 | 47.85 | 43.25 |

(BI) = before interesterification.
(AF) = after interesterification.
IV = Iodine value.
SFC = Solid Fat Content

Blend 4: Palm stearin IV 12/Palm kernel stearin IV 7/soybean oil IV 130 (77%/20%/3%)
Blend 5: Palm stearin IV 12/Palm kernel stearin IV 7/soybean oil IV 130 (75%/22%/3%).
Interesterified blends using IV 5 Palm Kernel stearin rather than IV 7, the results are more sharp mainly at 35° C. and 40° C.

For reference purposes, using only two group of fats: fractionated palm stearin IV 12 and fractionated palm kernel stearin IV 5, in order to have a close SFC value of the blend No 3 presented in Table 1, the amount of palm kernel stearin IV 5 is of 30-35% and 65-70% palm stearin IV 12. In contemplated embodiments, the use of the third group of fat of liquid component reduces the amount of palm kernel stearin from 30-35% to 22-25%. By these contemplated embodiments, the raw material cost is considerably reduced, as fractionated lauric fats are significantly more expensive than other fat components disclosed herein.

In Table 3, the SFC values, melting point and % saturated fatty acids of blends of the non-hydrogenated interesterified hard stock (blend 3) with regular liquid soybean oil are presented.

TABLE 3
Results of Solid Fat Content (SFC) values in blends of different
dosages of interesterified hard stock (blend No 3 presented in
table 1) in a liquid refined deodorized soybean oil.

| % Hard stock | SFC AT | SFC AT | SFC AT | SFC AT | SFC AT |
|---|---|---|---|---|---|
| (blend No 3) | 20° C. | 25° C. | 30° C. | 35° C. | 40° C. |
| 10 | 6.77 | 4.72 | 2.18 | 0 | 0 |
| 20 | 14.83 | 11.88 | 6.96 | 3.08 | 0 |
| 30 | 24.34 | 19.63 | 13.88 | 7.23 | 1.56 |
| 40 | 33.65 | 28.85 | 21.03 | 12.38 | 4.17 |
| 50 | 43.22 | 38.52 | 29.26 | 18.69 | 8.09 |
| 100 | 91.38 | 85.44 | 71.39 | 55.24 | 36.47 |

In Table 4, the SFC values of blends of the non-hydrogenated interesterified hard stock (blend 3) with liquid regular canola oil are presented.

TABLE 4
Results of SFC (Solid Fat Content) values in blends of different
dosages of interesterified hard stock (blend No 3 presented in
table 1) in a liquid refined deodorized regular canola oil.

| % Hard stock | SFC AT | SFC AT | SFC AT | SFC AT | SFC AT |
|---|---|---|---|---|---|
| (blend No 3) | 20° C. | 25° C. | 30° C. | 35° C. | 40° C. |
| 10 | 5.43 | 3.68 | 2.1 | 0 | 0 |
| 20 | 12.86 | 9.38 | 6.35 | 2.28 | 0 |
| 30 | 20.92 | 16.82 | 12.2 | 5.68 | 1.13 |
| 40 | 29.18 | 26.41 | 19.28 | 10.62 | 3.22 |
| 50 | 36.82 | 31.08 | 25.47 | 17.35 | 6.93 |
| 100 | 91.38 | 85.44 | 71.39 | 55.24 | 36.47 |

In Table 5, the saturated fatty acid (SFA) using various soft oils in combination of hard stock No 3 are compared with various soft oils. Note that using canola oil, sunflower oil and high oleic oils, the lower saturated levels are achieved. At 20% level of usage of hard stock No 3, the SFA can vary from 23% to 30%, depending of the soft oil used. The dosage of hard stock can be adjusted according the SFC value required as presented in Table 3.

TABLE 5
SFA content of blends of interesterified hard stock No 3 with different
soft oils in different proportions.

| | | | | % SFA | |
|---|---|---|---|---|---|
| | % SFA | % SFA | % SFA | with | % SFA |
| % HARD | with | with | with | High | with High |
| STOCK No 3 | regular | regular | regular | Oleic | Oleic |
| in Liquid Oil | SBO | CANOLA | SFO | SFO | Canola |
| 0 | 16 | 7 | 10 | 7.5 | 7 |
| 10 | 23.1 | 15.2 | 17.9 | 15.6 | 15.2 |
| 20 | 30.2 | 23.4 | 25.8 | 23.8 | 23.4 |
| 30 | 37.3 | 31.6 | 33.7 | 31.9 | 31.6 |
| 40 | 44.4 | 39.8 | 41.6 | 40.1 | 39.8 |
| 50 | 51.5 | 48 | 49.5 | 48.3 | 48 |
| 100 | 89.4 | 89.4 | 89.4 | 89.4 | 89.4 |

SBO: soybean oil
SFO: sunflower oil
SFA: saturated fatty acids

### Example 2

Blend No 3 (75% of palm stearin IV 12, 22% palm kernel stearin IV 5 and 3% refined soybean oil) was interesterified using the enzymatic technology rather than chemical interesterification.

Enzymatic interesterification of the fat blend No 3 was carried out in a continuous pilot plant which consist of four vertical columns of 200 g each enzyme holding capacity. Each column reactor having water jacketed and connected to a water bath thermostat to maintain the desired temperature. All columns were interconnected in series to simulate the industrial production process. A metal filter of 0.2 mm hole diameter was installed at the bottom of each column to retain the immobilized enzyme.

The reaction was carried out at 70° C., each column was dry packed with 200 g of Lipozyme TL IM (Novozymes). Hot water at 75° C. was circulated through the jacket of the columns and piping. The bleached and deodorized oil blend having free fatty acids 0.08% (as palmitic), peroxide value 0.3 meq/kg and moisture 0.05% was pumped at a feed rate of 2 kg oil per 1 kg enzyme per hour. The temperature of the oil feed and in the column was maintained at 70° C. The out coming oil from the bottom of the first reactor was feed to the top of the second reactor. The oil from the bottom of the second reactor was feed to the top of the third reactor and from third reactor to fourth reactor continuously. The interesterified oil collected from the fourth reactor was deodorized at 240° C. for 1 hour at 2 mbar absolute, direct steam was generated inside the deodorizer pumping distilled/degased water 2% per hour in a batch pilot deodorizer of 50 kg.

In Table 6, the interesterified blend No 3 was blended with 85% canola oil. The SFC of the blend is presented.

TABLE 6
% Solid Fat Content (SFC by pNMR) and Slip Melting Point (SMP) of
hard stock blend 3 enzymatically rearranged and after addition of
85% canola oil.

| TEMPERATURE | |
|---|---|
| ° C. | SFC % |
| 20 | 8.7 |
| 30 | 4.8 |
| 35 | 2.8 |
| 40 | 1.1 |
| SMP | 32° C. |

A low fat spread was produced in a margarine pilot plant of 50 kg/hr capacity, using the interesterified oil blend 15% with 85% canola oil.

Description of the Votating Conditions:

The oil blend was mixed and melted at 50° C. in the emulsion tank. The emulsifiers were dissolved in part of the oil blend 1 kg and heated at 70° C. and after melting the emulsifiers were added to the oil blend. All oil soluble ingredients were added to the oil phase (emulsifiers, beta carotene, flavours). Hot water (50 C) was mixed with all water soluble ingredients (salt, potassium sorbate) in a separate tank.

The water phase was transferred slowly to the emulsion tank and mixed with the oil phase. The emulsion at 50° C. was pumped to the votating pilot plant having the configuration of cool-pin-cool-pin. The flow rate was 45 kg/hr, in the first cooling the ammonia temperature of the external tube was of −12.8° C. and the product temperature of 21° C., the first pin machine with a rotation of 550 rpm. The second cooling cylinder the ammonia temperature was −16.7° C. and product temperature of 15° C., the second pin machine running at 550 rpm. Product was packed at 17° C. Finally the product was stored at 5° C. The product having good spreadability, good flavor release, good emulsion stability. In Table 7, the low fat spread formulation is presented.

TABLE 7
Low fat spread (60% fat) using interesterified hard stock and canola oil

| INGREDIENT | % |
|---|---|
| Hard stock (blend N3) | 12 |
| Canola oil | 48 |
| Distilled monoglycerides | 1 |
| Lecithin | 0.2 |
| Butter Flavour | 0.15 |
| Beta carotene (30% | 0.003 |
| suspension) | |
| Salt | 0.5 |
| Natural tocopherol mix | 0.02 |
| Citric acid | 0.035 |
| Vitamin A & D3 | 0.002 |
| Potassium sorbate | 0.1 |
| Water | 37.99 |

### Example 3

Production of icing shortening using the interesterified hard stock. The icing fat was produced by melting and mixing all the ingredients listed in Table 8 and texturized in a pilot votating line.

IN TABLE 8: Formulation of the icing shortening.

| INGREDIENT | % |
|---|---|
| Interesterified hard stock (blend No 3) | 25 |
| Refined Palm Olein IV 56 | 23 |
| High oleic sunflower oil | 50 |
| Distilled monoglyceride | 1.5 |
| Polysorbate | 0.5 |
| Ascorbyl palmitate | 0.02 |

TABLE 9
Solid fat content, saturated fatty acids and slip melting point
of the icing shortening made using the formulation presented
in Table 8.

| TEMPERATURE ° C. | SFC % |
|---|---|
| 20 | 23.3 |
| 30 | 15.13 |
| 35 | 11.07 |
| 40 | 8.94 |
| SFA | 35.45% |
| SMP | 47° C. |

Votating conditions: the fat blend was melted and mixed in the feed tank. The emulsifiers and the ascorbyl palmitate were melted in a portion of the liquid oil and blended with rest of the fat blend. The fat blend at 50° C. was pumped to the pilot votated line, having the configuration of cooling-pin-cooling-pin. The flow rate was maintained at 40 kg per hr. The first cooling the ammonia temperature was of 5.2° C. and the product temperature of 31° C., the pin machine was maintained at 550 rpm, in the second cooler the ammonia temperature was of 8.7° C. and product temperature of 26° C. The second pin machine was also maintained at 550 rpm. The product was packed at 28° C.

The texturized icing fat blend was tempered for three days at 22° C. before use. The product was stored at 5° C. for one week. Before use the product was warmed at 22° C.

Preparation of icing is outlined in Table 10 by using the icing shortening prepared with the hard stock and liquid oils and emulsifiers listed in Table 8.

TABLE 10
Icing formulation.

| INGREDIENT | % |
|---|---|
| TEXTURIZED ICING FAT | 27.5 |
| SUGAR | 65.14 |
| WATER | 7 |
| FLAVOR | 0.2 |
| SALT | 0.12 |
| CITRIC ACID | 0.04 |

### Process Conditions for Whipping the Icing Shortening:

The sugar and shortening (22° C.) was added to the mixer equipped with a paddle (Elextrolux BE5). Separately slurry was made with part of the water (50% of total) with the flavor and salt. The slurry was added to the bowl and mixed with the fat and sugar on low speed for 30 seconds. Mixing was stopped. The speed was switched to speed 2 and mixed for 3 minutes. Mixing was stopped again and switched to speed 1. A second slurry was made with remaining portion of water with the citric acid. The slurry was added to the bowl and mixed on low speed for 30 seconds. Finally the icing was mixed for additional 2 minutes on speed 2. Under these conditions the specific gravity was 0.7 and the temperature of 21° C. Low specific like 0.45-0.5 is achievable increasing the beating time, the fat content and the water up to 10%. Application of icing was performed well on toppings, decorations and cake fillings.

1. A process for preparing an edible hard stock for use in the formulation of margarines, spreads, icings, shortenings, frostings and other products that need a structural fat to hold at least some liquid unsaturated triglycerides or diglycerides, wherein the hard stock is a random interesterified product and has three groups of fats, the process comprising:
providing a first group of fats saturated by fractionation or by fully hydrogenation comprising more than 85% of C16:0 and C18:0 type of fatty acids;
providing a second group of fats saturated by fractionation or by full hydrogenation comprising more than 75% of C12:0 and C14:0;
providing a third group are of triglyceride liquid oils at ambient temperature, that contains C18 with total more than 80%; and
producing the edible hard stock by random interestification of the first group, the second group and the third group of fats.

2. The process of claim 1, wherein the random interestification proceeds chemically, enzymatically or by a combination thereof.

3. The process of claim 1, wherein the third group of triglyceride liquid oils comprise unsaturated oleic, linoleic or linolenic oil.

4. The process of claim 1, wherein the first group of fats is present in a range of about 25-80%.

5. The process of claim 4, wherein the first group of fats is present in a range of about 70-75%.

6. The process of claim 1, wherein the second group of fats is present in a range of about 10-35%.

7. The process of claim 6, wherein the second group of fats is present in a range of about 22-25%.

8. The process of claim 1, wherein the third group of fats is present in a range of about 1-30%.

9. The process of claim 8, wherein the third group of fats is present in a range of about 3-5%.
